(19) United States
(12) Patent Application Publication
(10) Pub. No.: US 2024/0181702 A1
(43) Pub. Date: Jun. 6, 2024

(54) OPTICS SHIELD

(71) Applicant: VulcanForms Inc., Burlington, MA (US)

(72) Inventors: Joseph D. Sandt, Evanston, IL (US); Richard A. Wessel, JR., Tiverton, RI (US); Stephen Elliot Wei, Medford, MA (US); Piotr Liebersbach, Chicopee, MA (US); Jason Shay Chalfant, Billerica, MA (US); Jeffrey M. LeBlanc, Burlington, MA (US)

(73) Assignee: VulcanForms Inc., Burlington, MA (US)

(21) Appl. No.: 18/524,485

(22) Filed: Nov. 30, 2023

Related U.S. Application Data
(60) Provisional application No. 63/429,219, filed on Dec. 1, 2022.

(51) Int. Cl. B29C 64/286; B29C 64/124; B29C 64/364

(52) U.S. Cl. CPC B29C 64/286; B29C 64/124; B29C 64/364; B33Y 10/00

(57) ABSTRACT

An additive manufacturing system has an optics assembly to direct laser energy toward a build surface to fuse a portion of a precursor material on the build surface. An optics shield of the additive manufacturing system has a debris shield including an optical window. The optical window permits laser energy to pass through the debris shield and prevents fusion products released during fusion of the precursor material from contacting a portion of the optics assembly. The optics shield has a gas flow passage between the optical window and the build surface. The gas flow passage directs a flow of gas away from the optical window to resist movement of the fusion products through the gas flow passage toward the debris shield.

### RELATED APPLICATIONS

This application claims priority under 35 U.S.C. § 119(e) to U.S. Provisional Application No. 63/429,219, filed Dec. 1, 2022, the content of which is incorporated by reference in its entirety for all purposes.

### FIELD

Disclosed embodiments are related to optics shields and related methods of use.

### BACKGROUND

In selective laser melting processes for additive manufacturing, one or more laser spots may be scanned over or otherwise applied to a thin layer of a powder. The powder that is exposed to laser energy may be melted and fused into a solid structure. Once a layer is completed, a new layer of powder may be laid down and the process may be repeated. The new layer may be selectively exposed to laser energy with at least some portions of powder material melted and fused onto the solid material from the prior layer. This process can be repeated many times in order to build up a three-dimensional shape of nearly any form.

### SUMMARY

In some embodiments, an optics shield may be provided for use in an additive manufacturing system having an optics assembly configured to direct laser energy toward a build surface to fuse a portion of a precursor material on the build surface. The optics shield may comprise a debris shield and a gas flow passage. The debris shield may include an optical window configured to permit the laser energy to pass through the debris shield and configured to prevent fusion products released during fusion of the precursor material from contacting a portion of the optics assembly. The gas flow passage may be configured for positioning between the optical window and the build surface, and may be configured to direct a flow of gas away from the optical window to resist movement of the fusion products through the gas flow passage toward the debris shield.

In some embodiments, the optics shield may further comprise a gas flow plenum coupled to an entrance of the gas flow passage. Further, the gas flow plenum may include a gas inlet for coupling to a gas source. The gas inlet may comprise a muffler or a diffuser. Additionally or alternatively, the debris shield may be disposed within the gas flow plenum. In some embodiments, an entrance of the gas flow passage may comprise a plurality of nozzles. The plurality of nozzles may form crenellations at the entrance of the gas flow passage. Additionally or alternatively, each nozzle may be shaped to guide a flow of gas into the nozzle.

In some embodiments, an entrance of the gas flow passage may include first and second groups of nozzles configured to direct gas flow toward each other. The gas flow passage may include a tubular wall having a proximal end portion and may extend away from the debris shield to a distal end portion. The proximal end portion may include the first and second groups of nozzles. In some embodiments, the tubular wall may have first and second flat wall sections that extend from the proximal end portion to the distal end portion. The proximal end portion of the first flat wall section may include the first group of nozzles and the proximal end portion of the second flat wall section may include the second group of nozzles. In some embodiments, each nozzle of the first and second groups of nozzles may comprise a gap formed in the respective first or second flat wall section. Additionally or alternatively, the first and second flat wall sections may taper toward each from the proximal end portion to the distal end portion.

In some embodiments, the gas flow passage may be defined by a tubular wall having a proximal end portion, and may extend away from the debris shield to a distal end portion. The proximal end portion may include a plurality of gaps in the tubular wall forming a plurality of nozzles to direct the flow of gas into the gas flow passage. In some embodiments, the debris shield may include a portion positioned over the plurality of nozzles at the proximal end portion of the tubular wall. Additionally, the portion of the debris shield positioned over the plurality of nozzles may be spaced apart from the tubular wall.

In some embodiments, the debris shield may further comprise a frame at least partially surrounding the optical window. The frame may be configured to selectively engage with a locating mechanism of the optics shield. In some embodiments, the frame may include a locating bore sized and shaped to selectively receive a locating pin of the locating mechanism. The locating pin may be configured to be selectively engaged with or disengaged from the locating bore. Additionally, in some embodiments, the locating pin may be configured to be selectively engaged with or disengaged from the locating bore by a camming arrangement. The camming arrangement may comprise a spring in contact with the locating pin providing a biasing force to urge the locating pin in a first direction to engage the locating pin with the locating bore. A cam follower of the locating pin may be biased in the first direction against a cam fixed to a camshaft. A cam lever at an end of the camshaft may be configured to be turned by a user to rotate the cam to urge the locating pin in a second direction opposite the first direction to overcome the biasing force to selectively disengage the locating pin from the locating bore.

In some embodiments, the optics shield may further comprise a housing. The gas flow passage may extend from or through a portion of the housing, and the debris shield may be insertable into and removable from the housing through an opening of the housing. In some embodiments, the housing may for a gas flow plenum couplable between a gas source and an entrance of the gas flow passage. The debris shield may be insertable into and removable from the gas flow plenum through a slot of the housing, and the slot may be configured to form a gas-tight seal with the debris shield.

Some embodiments may include a method of resisting contact with a portion of an optics assembly of an additive manufacturing system by fusion products released during fusion of a precursor material on a build surface in an additive manufacturing process. The method may comprise passing laser energy through an optical window of a debris shield disposed between a portion of the optics assembly and the build surface, and producing a flow of gas towards the build surface through a gas flow passage disposed between the optical window and the build surface. The flow of gas may resist movement of the fusion products through the gas flow passage towards the portion of the optics assembly. In some embodiments, producing the flow of gas towards the build surface through the gas flow passage may comprise providing gas in a gas flow plenum and causing the gas to flow from the gas flow plenum into the gas flow passage. In some such embodiments, providing gas in the gas flow plenum may comprise introducing the flow of gas into the gas flow plenum through a muffler or diffuser. Additionally or alternatively, causing the gas to flow into the gas flow passage may comprise causing the gas to flow around the debris shield within the gas flow plenum into the gas flow passage.

In some embodiments, producing the flow of gas towards the build surface through the gas flow passage may comprise passing the flow of gas through a plurality of nozzles formed in an entrance of the gas flow passage. Passing the flow of gas through the plurality of nozzles may comprise passing a first portion of the flow of gas through a first group of the plurality of nozzles and passing a second portion of the flow of gas through a second group of the plurality of nozzles. In some embodiments, the first and second portions of the flow of gas may flow toward each other. Additionally or alternatively, passing the flow of gas through the plurality of nozzles may comprise passing the flow of gas through a plurality of gaps formed in the entrance of the gas flow passage. Passing the flow of gas through the plurality of gaps may comprise passing a first portion of the flow of gas through a first group of the plurality of gaps and passing a second portion of the flow of gas through a second group of the plurality of gaps. In some embodiments, the first and second portions of the flow of gas may flow toward each other.

In some embodiments, the debris shield may be a first debris shield, and the method may further comprise removing the first debris shield from an optics shield of the additive manufacturing system and installing a second debris shield in the optics shield. In some embodiments, removing the first debris shield may comprise disengaging a locating pin of the optics shield from a locating bore of the debris shield.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 is a schematic illustration an additive manufacturing system including an optics shield according to some embodiments;

FIG. 2 is a perspective view of an optics shield according to some embodiments;

FIG. 3 is a perspective view of a gas flow passage of an optics shield according to some embodiments;

FIG. 4A is a top view of an optics shield depicting a locking mechanism engaged with a debris shield, according to some embodiments;

FIG. 4B is a top view of an optics shield depicting a locking mechanism disengaged from a debris shield, according to some embodiments; and

FIG. 5 is a cross-sectional view of the optics shield of FIG. 4B, depicting a flow of gas according to some embodiments.

### DETAILED DESCRIPTION

Some additive manufacturing systems may iteratively melt and/or fuse selective portions of sequential layers of precursor material to build a product from the fused material. For example, some laser powder bed fusion (LPBF) additive manufacturing systems may use lasers to melt and/or fuse portions of sequential layers of a precursor material such as a powdered metal, plastic, polymer, or other material. In some embodiments, the melted portion of the precursor material may be referred to as a melt pool. In some applications, dynamics within the melt pool may cause gasification of the precursor material, which may result in the generation of fumes from the melt pool. Moreover, the gasification and rapid expansion of powdered and molten material may also cause the melt pool to eject solid and/or liquid particles from the melt pool. Various types of ejecta, debris or other fusion products generated during a laser melting process (e.g., individual powder particles, partially fused powder particles, molten droplets or cooled molten droplets, fumes from the melt pool, etc.) may cause a number of problems during the build process. For example, fusion products can deposit and accumulate on various portions of an optics assembly of an additive manufacturing system, including various optical components of the optics assembly. In some applications, the accumulated fusion products may interfere with operation of the optics assembly or additive manufacturing system, for example by damaging an optical component and/or causing an optical component to malfunction.

Accordingly, some additive manufacturing system may include an optics shield configured to protect a portion of an optics assembly (e.g., an optical component) from contact with fusion products ejected from a melt pool or otherwise generated during the additive manufacturing process. An optics shield may include an optical window which is optically transmissive to allow laser energy to be transmitted therethrough. The window and/or other portion(s) of the optics shield may provide a physical barrier between a portion of the optics assembly and the melt pool or other build surface area. In some applications, fusion products may accumulate on an optical window and/or other portion(s) of an optics shield to the point that the accumulated fusion products may interfere with the laser energy being transmitted through the window. Accordingly, it may become desirable to replace at least a portion of an optics shield (e.g., an optical window) at various times before, after, or during a build process, for example between layers of a build or between consecutive builds. However, replacement of an optics shield or a portion thereof may be time consuming or inefficient, particularly when replacement is needed during a build process. Replacement of an optics shield may require downtime or interruption during a build process, during which the system may not be actively manufacturing a part. Therefore, it will be appreciated that in some applications, it may be desirable to reduce a time required to replace an optics shield or a portion thereof.

In view of the above, the inventors have recognized and appreciated the benefits of an optics shield configured to receive a replaceable debris shield, the debris shield including an optical window. In various embodiments, the optics shield may be configured to receive the debris shield in any appropriate arrangement, including snaps, fasteners, clamps, friction fits, magnets, threaded arrangements, or any other mechanism for removably affixing a debris shield to or within an optics shield. In some embodiments, the debris shield may be configured to selectively engage with and/or be reliably positioned by a locating mechanism of the optics shield. For example, in some embodiments, the debris shield may include a frame at least partially surrounding the optical window, and the frame may have a locating bore configured to receive a locating pin of the optics shield. In some embodiments, optics shield may include a camming arrangement including one or more locating pins which may be extendable and retractable by the camming arrangement to selectively engage or disengage a debris shield. Some such arrangements may facilitate the efficient removal and replacement as well as reliable positioning of a debris shield within the optics shield.

Further, because replacement of an optics shield or portion thereof (e.g., a debris shield) may require downtime or process interruption even in embodiments with an efficient replacement mechanism as described above, it may be desirable to prolong a useful life of an optics shield or a replaceable portion thereof. Accordingly, the inventors have recognized and appreciated the benefits of an optics shield which can resist contact or accumulation by fusion products on the optical window or other component of the optics shield. In some embodiments, a flow of gas may be provided between the optical window and the build surface to resist movement of fusion products toward the window. For example, in some embodiments, an optics shield may include a gas flow passage disposed between the build surface and a debris shield or an optical window. The gas flow passage may be fluidly coupled to a gas source to produce a flow of gas within the gas flow passage. In some embodiments, the flow of gas may be directed outwardly, for example away from the optical window and/or toward the build surface, to resist movement of fusion products toward the optical window, although it will be appreciated that a flow of gas may be directed in any appropriate direction or combination/sequence of directions, including at least partially across the optical window. Such gas flow to help resist fusion products from reaching an optics shield can be employed whether one or more portions of the optics shield are replaceable or not.

Further to the above, in some embodiments, an optics shield having a gas flow passage may be configured to provide a desired flow characteristic in a flow of gas through the gas flow passage. For example, in embodiments where a particular flow rate or flow velocity may be desired to provide sufficient resistance to movement of fusion products having a particular expected particle size or other characteristic, the gas flow passage may be fluidly coupled to a gas source having an appropriate gas flow capacity to achieve the desired flow rate or flow velocity. Additionally or alternatively, in some embodiments, it may be desirable to produce a steady uniform flow of gas, for example to provide consistent resistance across a cross-sectional area and/or along a length of the gas flow passage. In some embodiments, a steady uniform flow of gas may be laminar, stable, and/or uniform across at least a portion of the flow, may include some small scale turbulence, and/or may be substantially unchanging with respect to time, such that movement of fusion products may meet substantially consistent resistance throughout the gas flow passage.

In view of the above, the inventors have recognized and appreciated the benefits of an optics shield configured to produce a steady uniform flow or other desired flow of gas through a gas flow passage, e.g., to resist fusion products from traveling through the gas flow passage to the optics shield. In some embodiments, an optics shield may include a gas flow plenum upstream of the gas flow passage. The plenum may be configured to quiesce the flow of gas, for example by controlling or slowing a gas flow velocity, to facilitate a steady uniform flow condition at, near, or through an entrance of the gas flow passage or provide other gas flow characteristics. Additionally or alternatively, the gas flow passage may be configured to produce or facilitate a steady uniform flow of gas therethrough, for example by including one or more nozzles. In some embodiments, an entrance of a gas flow passage may include a plurality of nozzles configured to produce a steady uniform flow condition through the entrance and/or through at least a portion of the gas flow passage. For example, in some embodiments, the gas flow passage may include first and second groups of nozzles disposed, respectively, along first and second sections of a tubular wall of the gas flow passage. In some embodiments, each of the first and second sections of the wall may be disposed on opposite sides of the gas flow passage, and each section may be flat. In some embodiments, each nozzle may be configured to direct gas across the gas flow passage and into the opposite flat section. Further, each flat section may be configured to redirect gas from an opposing nozzle toward the build surface, such that gas from each nozzle converges with gas from adjacent nozzles in a flow of gas directed toward the build surface. Although steady uniform flow has been described as beneficial in some applications, it will be appreciated that turbulent, unsteady, fluctuating, or unstable, or any other flow through a gas flow passage may be sufficient or beneficial in some applications, and that the disclosure is not limited to embodiments configured to produce only laminar, uniform, or steady flow in any portion of the gas flow passage. Further, some embodiments may be configured to produce flow in a desired direction (e.g., in an outward direction away from an optical window, and/or in a direction across an optical window), without any particular flow condition being necessary or desirable.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

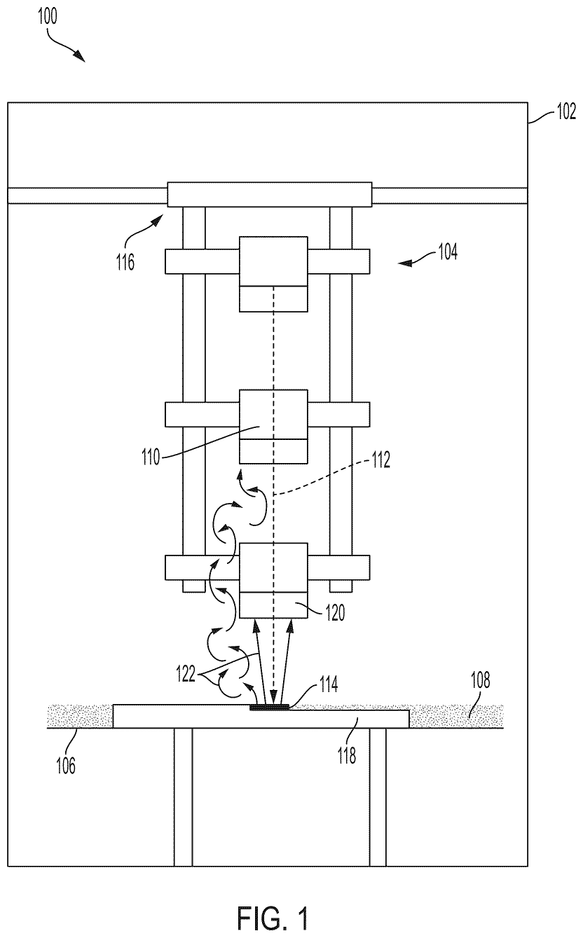

FIG. 1 shows a schematic depiction of an additive manufacturing system 100 according to some embodiments. The additive manufacturing system 100 may comprise a build volume 102 that contains an optics assembly 104 positioned above a build surface 106 that supports a precursor material 108. The precursor material 108 may be any appropriate material for additive manufacturing, including any appropriate plastic, metal, polymer, composite, or other powdered or non-powdered material. The optics assembly 104 may include one or more optical components 110, which may be configured to direct incident laser energy 112 along a beam path through the optics assembly 104 toward the build surface 106. At a point where the laser energy 112 is incident on the precursor material 108, the incident laser energy 112 may create a melt pool 114 by melting a portion of the precursor material. The optics assembly 104 may be moveable relative to the build surface by a gantry system 116 to move the incident laser energy 112 across various portions of the precursor material 108. After being exposed to the laser energy, melted portions of precursor material may cool, solidify, and/or fuse together. When adjacent portions of the precursor material have previously been melted, fused, and/or solidified, the melted portion may fuse with the adjacent portions to form a built part 118. This process may be conducted iteratively, with a new layer of precursor material being deposited on top of the built part 118 until the built part is completed. As noted above, the melt pool 114 may eject various fusion products 122, including particles, fumes, or gases produced by the incident laser energy 112 on the precursor material 108. Accordingly, in some embodiments, at least one optical component 110 may be positioned behind an optics shield 120 such that at least a portion of the ejected fusion products 122 may be deposited on an optics shield 120 instead of an optical component 110, thereby protecting the optical component from damage or malfunction.

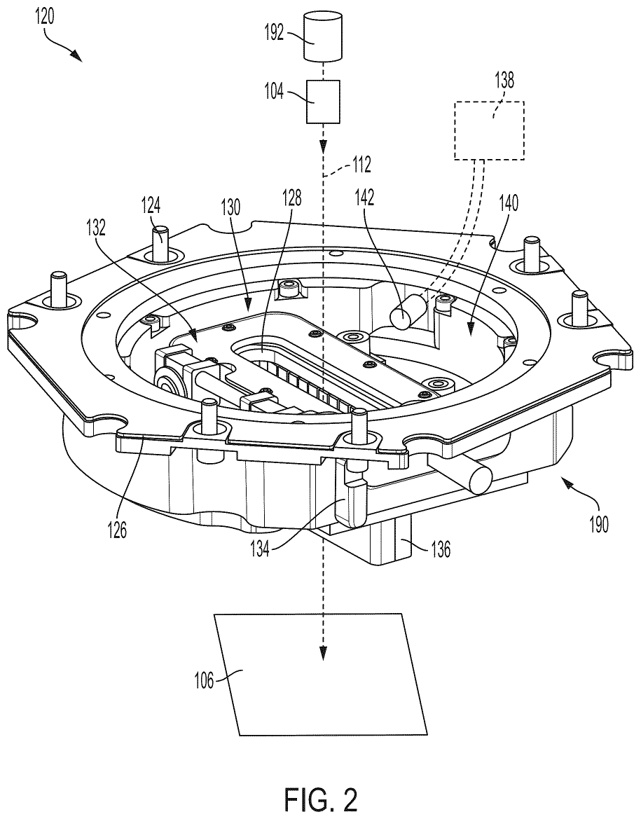

FIG. 2 depicts a perspective view of an optics shield 120 according to some embodiments. In some embodiments, the laser energy 112 may be directed from a laser energy source 192, through an optics assembly 104 and toward a build surface 106. In the figure, the laser energy source, optics assembly, and build surface are shown schematically to depict the functional arrangement of an additive manufacturing system according to some embodiments. In the embodiment shown, the optics shield 120 may be removed from the optics assembly. The optics shield 120 may include a housing 190, which may be configured to be removably coupled or couplable with an optics assembly or an optical component of an additive manufacturing system, for example using one or more mounting features 124 configured to engage with corresponding holes or bores of an optics assembly or optical component. The mounting features 124 may be any appropriate element for coupling the optics shield to and optical component or optics assembly, including threaded fasteners, snap fasteners, clamps, magnetic fasteners, mounting pins, or any other appropriate mechanism. In some embodiments, only a single mounting feature may be included, for example a threaded portion extending around a periphery or other portion of the optics shield and configured to thread onto a corresponding threaded portion of an optics assembly or optical component. Additionally, a mounting interface 126 may be disposed on a side or portion of the optics shield 120 to provide a desired interaction between the optics shield and the optics assembly or optical component. For example, a mounting interface 126 may comprise a geometry configured to correspond to a geometry of the optics assembly or optical component to facilitate a tight fit at the interface, and/or the mounting interface 126 may comprise a gasket, an O-ring, or other sealing interface to facilitate a gas-tight seal at the interface.

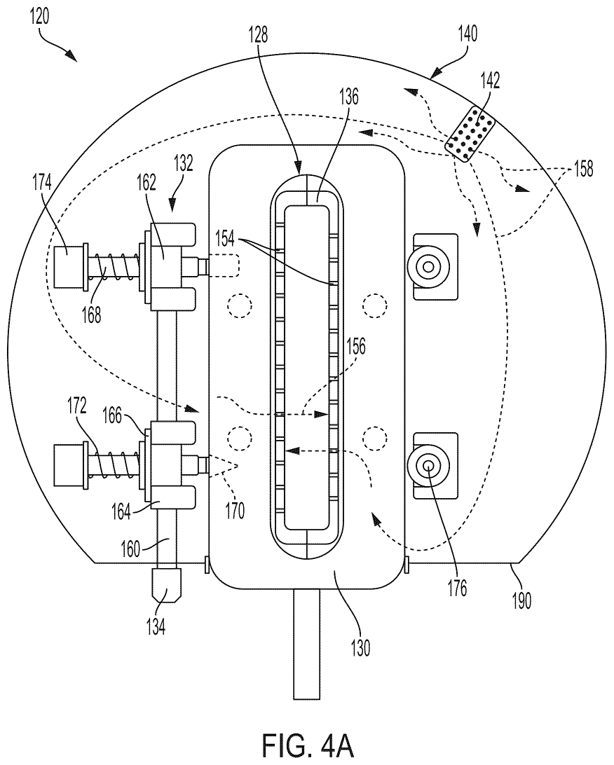

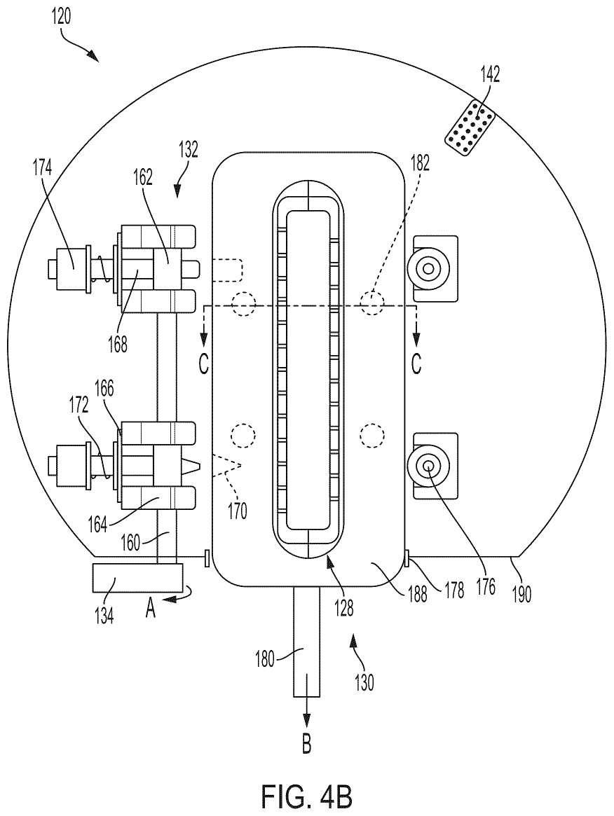

The optics shield 120 may include an optical window 128, which may be optically transmissive or otherwise configured to permit laser energy 112 to pass through the optics shield 120. In some embodiments, the optical window 128 may be included in a debris shield 130, although it will be appreciated that in other embodiments an optical window may be incorporated directly into an optics shield. In some embodiments which include a debris shield 130, the debris shield 130 may be removable from the optics shield 120. For example, in some embodiments the optics shield 120 may optionally include a camming arrangement 132 operable by a cam lever 134 to engage the debris shield within the optics shield, or to disengage the debris shield to allow the debris shield to be removed and replaced. The operation of the illustrated camming arrangement 132 will be described with reference to FIGS. 4A-4B, although it will be appreciated that a debris shield may be selectively couplable to an optics shield by any appropriate coupling mechanism. For example, in some embodiments, the debris shield and the optics shield may have corresponding threaded portions, or the debris shield may be coupled to the optics shield by fasteners, snap fits, magnetic coupling, or any other appropriate mechanism. In some embodiments, the debris shield may be coupled or otherwise mounted to an optics shield without any coupling mechanism, e.g., the debris shield may be simply inserted into an opening of the optics shield and held in place by friction fit.

As noted above, some embodiments of an optics shield 120 may include a flow of gas to resist movement of fusion products toward the optical window 128 and/or debris shield 130. For example, in some embodiments, an optics shield 120 may include a gas flow passage 136 fluidly coupled to a gas source 138 (shown schematically). The gas flow passage 136 may be configured to direct a flow of gas provided by the gas source 138. For example, in some embodiments the gas flow passage 136 may comprise a tubular wall through which the flow of gas may be directed. In some embodiments, the gas flow passage 136 may be disposed between the optical window 128 and a build surface 106, such that the gas flow passage 136 may direct the flow of gas at least partially toward the build surface 106 to resist movement of fusion products from the build surface toward the optical window 128, the debris shield 130, and/or the optics shield 120.

In some embodiments, the optics shield 120 may further include a gas flow plenum 140 fluidly coupled between the gas source 138 and the gas flow passage 136. The gas flow plenum 140 may be an enclosed or partially enclosed volume formed by the housing 190. The gas flow plenum may be configured to quiesce, modulate, or otherwise influence the flow of gas through the optics shield 120 upstream of the gas flow passage, for example by reducing a velocity of or otherwise controlling the gas flow. In some embodiments, the gas flow plenum may at least partially surround the debris shield, the optical window, and/or the gas flow passage, such that the debris shield, the optical window, and/or the gas flow passage may be at least partially disposed within the gas flow plenum. Additionally, the optics shield 120 may include at least one gas inlet 142 to fluidly couple the optics shield, the gas flow plenum, and/or the gas flow passage to the gas source 140. In some embodiments, the gas inlet 142 may be configured to reduce a velocity of the flow of gas. For example, in some embodiments, the gas inlet 142 may comprise a muffler (e.g., a pneumatic muffler having perforations, mesh, slots, or other apertures through which the gas may enter the optics shield) or a diffuser (e.g., a directional diffuser, a slot diffuser, a swirl diffuser, etc.), although in other embodiments the gas inlet may be a terminating point of a gas conduit.

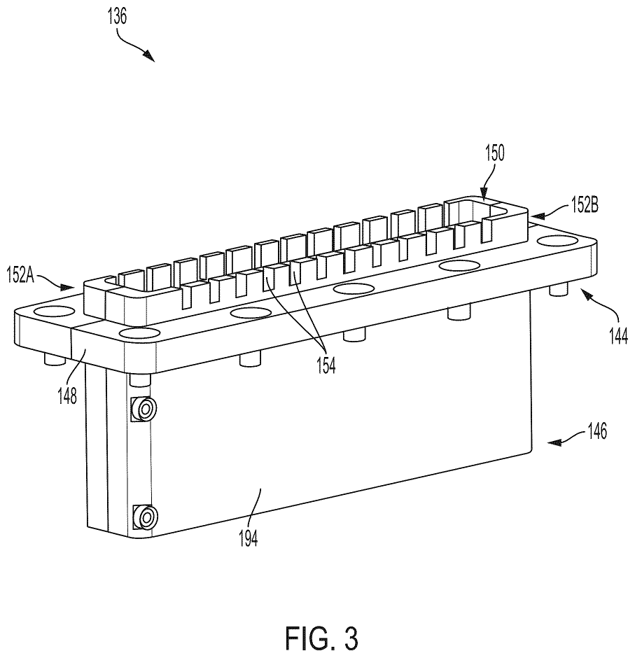

FIG. 3 shows a gas flow passage 136 which has been removed from an optics shield, according to some embodiments. The gas flow passage may have a proximal end portion 144 configured to be disposed at, near, or within an optics shield, and a distal end portion 146 configured to extend away from the optics shield or debris shield (e.g., towards a build surface, in some embodiments). In some embodiments, the proximal end portion may include a mounting plate 148 configured to engage with or couple to an optics shield, for example using threaded fasteners, snaps, magnets, or any other appropriate coupling mechanism. Further, the proximal end portion 144 may include an entrance 150 of the gas flow passage, which may be configured to receive a flow of gas from the optics shield and/or a gas source to which the gas flow passage is fluidly coupled.

The gas flow passage 136 may include a tubular wall 194 configured to permit or direct a flow of gas therethrough. For example, the tubular wall 194 may extend from the proximal end portion 144 to the distal end portion 146, and may be configured to permit or direct a flow of gas from the proximal end portion to the distal end portion. In various embodiments, a tubular wall may be formed in any appropriate regular geometry (e.g., having a cross-section that is circular, elliptical, rectilinear, polygonal, etc.) or irregular geometry (e.g., having a contoured cross-section, or a variable cross-section such as a cone or other tapered geometry). In some embodiments, the tubular wall may be sized and shaped to permit incident laser energy to pass therethrough. As will be appreciated, a size and shape of a laser beam may vary along a beam path. Accordingly, a gas flow passage or tubular wall thereof may be sized and shaped to correspond to a size and/or shape of a laser beam at any desired point along the beam path. In some embodiments, a tubular wall may be formed in a rectilinear geometry having two or more sections which are flat and/or parallel to one another. For example, the tubular wall 194 may include a first flat wall section 152A and a second flat wall section 152B.

Additionally, an entrance 150 of a gas flow passage may be configured to produce or direct a flow of gas through the gas flow passage. In some embodiments, a proximal end portion or an entrance of a gas flow passage may include one or more nozzles. For example, the entrance 150 may include a plurality of nozzles 154. In various embodiments, a nozzle may be formed in any appropriate construction, including a through-hole extending through a wall of the entrance, one or more protruding portions extending from a wall, a slot in a wall, or any other appropriate structure or configuration that defines a gap which functions as a nozzle. Additionally, a nozzle may have any appropriate shape, contour, or curvature, including shapes configured to influence a flow of gas through the nozzle or guide a flow of gas into the nozzle. In some embodiments, a plurality of nozzles may be formed as a series of gaps in a wall, e.g., a plurality of crenellations at an end of the wall may form multiple gaps through which gas may flow into the entrance. Additionally, in some embodiments, a plurality of nozzles may include a first group of nozzles disposed along the first flat wall section 152A and a second group of nozzles disposed along the second flat wall section 152B. Further, each group of nozzles may be formed as a series of gaps, e.g., each group of gaps formed by a respective plurality of crenellations as shown.

As shown in the top view of FIG. 4A, a first group of nozzles 154 disposed along a first flat wall section of a gas flow passage entrance may, in some embodiments, be offset from a second group of nozzles disposed along a second flat wall section of the entrance. Such offset arrangements may allow gas to flow through each nozzle and be directed at an opposing section of wall, as indicated by arrows 156, rather than being directed at an opposing nozzle. This may allow the first and second groups of nozzles to direct gas flow toward each other while reducing interference between a first portion of gas flow from the first group of nozzles and a second portion of gas flow from the second group of nozzles. In embodiments where steady uniform flow is desired, this may facilitate steady uniform flow by reducing large scale turbulence and/or other unstable flow conditions which may result from interference between opposing gas flows. In some embodiments, gas may flow through a nozzle and toward an opposing wall portion between two opposing nozzles, although it should be appreciated that gas may flow through a nozzle and toward any section of an opposing wall, including an opposing nozzle.

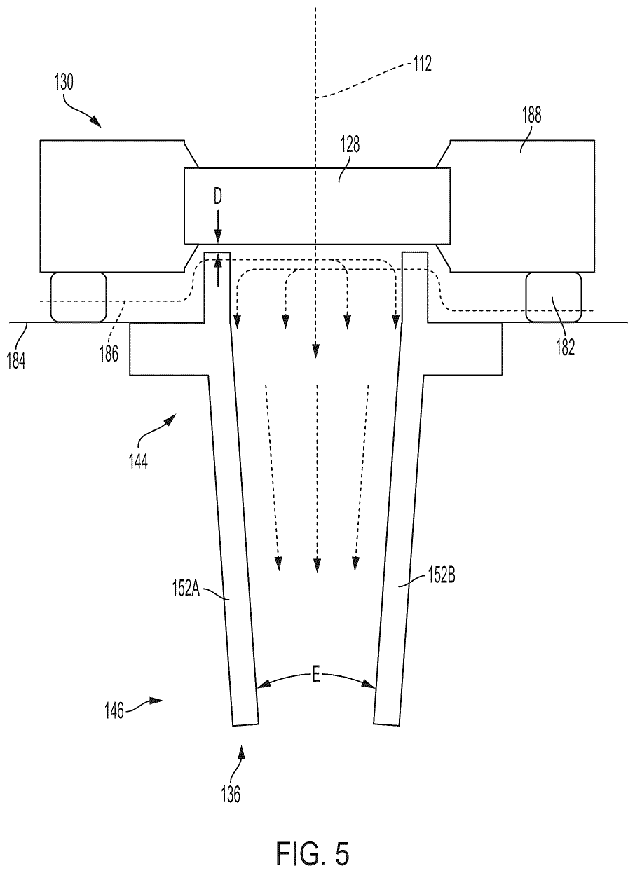

Additionally shown in FIG. 4A, an optics shield 120 may include a gas inlet 142, which may introduce a flow of gas from a gas source into a gas flow plenum 140. The gas flow plenum 140 may comprise a volume at least partially internal to or enclosed by the optics shield, such that the flow of gas may be permitted to circulate through the volume. In some embodiments, the gas inlet 142 may comprise a muffler or diffuser, such that the flow of gas is introduced in more than one direction as indicated by arrows 158. The gas flow plenum 140 may facilitate the introduction of gas into the gas flow passage 136 under a desired flow condition, for example a desired pressure, flow velocity, volumetric flow rate, or laminarity. As will be appreciated with reference to FIG. 5, gas may be permitted to enter the gas flow passage through a space or other gap between the debris shield 130 and the optics shield which is hidden from view in FIG. 4A.

FIG. 4A further depicts a locating mechanism of an optics shield according to some embodiments. As noted above, some optics shields may be configured to selectively engage or disengage with a debris shield or other component of the optics shield to allow removal and replacement of the debris shield. In some embodiments, a debris shield 130 may be selectively engageable with a camming arrangement 132 of the optics shield to allow removal and replacement as well as reliable positioning of a debris shield within the optics shield. A camming arrangement may include a cam lever 134, which may be disposed on an exterior portion of the optics shield 120 (e.g., external to the housing 190) to allow a user to turn the cam lever. The cam lever 134 may be fixed to a cam shaft 160. The cam shaft 160 may extend from the exterior portion of the optics shield, through a wall of the optics shield or housing, and into an interior portion of the optics shield (e.g., into the gas flow plenum 140). The cam shaft 160 may extend through one or more shaft bushing posts 162, each configured to support the cam shaft and maintain alignment of the cam shaft during rotation. Additionally, one or more cams 164 may be fixed to the cam shaft 160 at appropriate points along a length of the cam shaft. Each cam 164 may be in contact with a cam follower 166, which may be fixed to or formed as part of a locating pin 168. Each locating pin may be configured to engage with a portion of a debris shield. For example, each locating pin may be sized and shaped to be selectively insertable into and removable from a correspondingly sized and shaped locating bore 170 of the debris shield 130. Additionally, each locating pin 168 may be supported by at least one pin bushing post 174 to support the locating pin during operation of the camming arrangement. A spring 172 may be provided in conjunction with each locating pin to bias the locating pin in a desired direction. For example, a spring 172 may be disposed between a cam follower 166 and a pin bushing post 174 to urge the cam follower and associated locating pin 168 toward an extended position (e.g., in a first direction toward the debris shield) in which the locating pin may be engaged with a debris shield 130 disposed within the optics shield. With the cam shaft 160 in the position shown in FIG. 4A, the locating pins 168 may engage with the frame of the debris shield 130. However, with the cam shaft 160 rotated to the position shown in FIG. 4B, the cams 162 move the cam followers 166 away from the debris shield 130 so the locating pins 168 disengage from the shield 130. Although some embodiments may include a camming mechanism such as the one described above, it will be appreciated that a debris shield may be selectively engageable with an optics shield using any appropriate arrangement, including threaded arrangements, magnetic arrangements, snap fits, friction fits, or any other appropriate mechanism.

In some embodiments, one or more locating pins 168 may cooperate with one or more locating bores 170 of a debris shield to fix a position of the debris shield, for example by constraining movement of the debris shield in at least one direction. Various embodiments may include locating pins and locating bores of any appropriate geometry, including tapered geometries, cylindrical geometries, squared or rectilinear geometries, spherical geometries, or any appropriate regular or irregular geometries. Additionally or alternatively, movement of the debris shield may be constrained using one or more reference features. For example, in some embodiments, contact with a locating pin 168 may urge the debris shield 130 toward one or more reference features 176 such that the debris shield makes contact with the reference feature(s) 176. In some embodiments, a reference feature or reference features may define a reference plane, such that a side or portion of a debris shield which is in contact with the reference feature(s) may lie within or be parallel to the reference plane.

As shown in FIG. 4B, the camming lever 134 may be turned, for example in the direction of arrow A (clockwise as viewed in FIG. 2), to move the locating pins 168 from the extended position to a retracted position, in which the locating pins are disengaged from the locating bores 170. Turning of the cam lever 134 may rotate each of the cams 164, which may have an oblong shape such that rotation of a cam 164 causes the cam to move the cam follower 166. Each cam 164 may urge a cam follower 166 and associated locating pin 168 in a direction opposing a biasing force from a spring 172. When a debris shield 130 is disposed in the optics shield, each cam may urge a cam follower and associated locating pin away from the debris shield, such that the locating pin may disengage from an associated locating bore. Disengagement of the locating pins from the locating bores may allow the debris shield 130 to be removed from the optics shield and replaced with a second debris shield. In some embodiments, the debris shield 130 may be removed through a slot 178, which may be a hole or gap in the housing 190 sized and shaped to receive a debris shield. In some embodiments, the slot 178 may be configured to form a gas-tight seal between the debris shield and the optics shield, for example by including a gasket, o-ring, or other appropriate gas-tight interface. A user may remove the debris shield 130 by pulling the debris shield through the slot 178 in the direction B, for example by grasping and pulling on a handle 180 of the debris shield which may extend from a surface or external portion of the debris shield. For example, a debris shield may include a frame 188 which may at least partially surround an optical window 128. In some embodiments, a handle 180 may extend from the frame 188.

FIG. 5 depicts a flow of gas through a gas flow passage of an optics shield according to some embodiments. In some embodiments, an optics shield may be configured to dispose a debris shield or optical window at a desired position with respect to a gas flow passage. For example, a debris shield or a portion thereof (e.g., a frame or optical window) may be positioned adjacent to or over the proximal end of the gas flow passage, such that the debris shield may be adjacent to or over the plurality of nozzles. In addition to or instead of the locating mechanisms described above, an optics shield may include at least one support feature 182 configured to locate the debris shield 130 or optical window with respect to the gas flow passage 136. A support feature may comprise any structure appropriate for supporting a debris shield at a desired position, such as a post or column extending a desired distance from the surface of the optics shield. In some embodiments, a support feature 182 may supportively contact a frame 188 of a debris shield, for example to prevent contact with or damage to the optical window 128, which may disrupt laser energy passing through the optical window. However, in some embodiments, a support feature may additionally or alternatively supportively contact the optical window, for example where contact may occur in an area of the optical window away from an area through which laser energy may be directed.

In some embodiments, a gas flow passage 136 may include a first flat wall section 152A and a second flat wall section 152B, each extending from a proximal end portion 144 to a distal end portion 146 away from the debris shield 130. The first and second flat wall sections 152A, 152B may be disposed on opposing sides of the gas flow passage, and may be parallel along at least a portion of their respective lengths. Additionally or alternatively, at least one of the first or second flat wall section may taper towards or away from the other flat wall section along at least a portion of its length. For example, each of the first and second flat wall sections may taper toward each other from the proximal end portion to the distal end portion to narrow the gas flow passage along the direction of gas flow as shown. In some embodiments, the gas flow passage may include inner wall surfaces that taper toward and/or away from each other and that are parallel to each other, e.g., inner wall surfaces may initially taper towards each other from the proximal end portion toward the distal end portion and transition to being parallel to each other at or near the distal end. In various embodiments, a flat wall section, or any other portion of a gas flow passage or a tubular wall thereof, may taper at any appropriate angle. In some embodiments, a first flat wall section 152A may form an angle E with respect to a second flat wall section 152B, although it will be appreciated that a portion of a tubular wall may form an angle with any other appropriate geometric reference (e.g., a central, vertical, or horizontal axis or plane of the gas flow passage, debris shield, or optics shield). In various embodiments, the angle E between the first and second flat wall sections 152A, 152B may be any appropriate angle, including 0.5°, 10, 3°, 5°, 7°, 10°, 20°, 30°, 45°, any intermediate angle therebetween, or any other appropriate angle greater than or less than the foregoing, as the disclosure is not limited in this regard. Combinations and ranges are also contemplated, for example between 0.5° and 45°, between 10 and 10°, between 3° and 7°, and any other appropriate combination or range. In some embodiments, two portions of a tubular wall may taper away from each other from the proximal end portion to the distal end portion at any appropriate angle, such that the gas flow passage may widen along the direction of gas flow. In some embodiments, two portions of a tubular wall may be parallel or substantially parallel, such that the gas flow passage may have a consistent width along the direction of gas flow.

Each flat wall section may include a respective group of nozzles at or near an entrance to the gas flow passage to permit gas to flow into the gas flow passage through the flat wall section. In operation, a flow of gas 186 may flow between a surface 184 of the optics shield and the debris shield 130, through a nozzle formed in the first flat wall portion 152A, and into the gas flow passage 136. The flow of gas 186 may be directed or guided by the nozzle toward the second flat wall portion 152B on an opposing side of the gas flow passage, where it may turn toward the distal end portion 146 of the gas flow passage. In some embodiments, the first group of nozzles may be offset from the second group of nozzles as described above, such that each nozzle may direct gas across the gas flow passage and toward an opposing section of wall. It will be appreciated that a gas flow velocity may be tuned or adjusted to achieve a desired flow condition or direction (e.g., to produce steady uniform flow, outward flow, and/or any other type of flow), for example by adjusting a pressure or velocity of a gas provided by a gas source, or by providing a gas flow plenum having appropriate dimensions surrounding the entrance to the gas flow passage. However, it will further be appreciated that in some embodiments, the degree of gas flow steadiness or uniformity may vary. For example, in some embodiments, the flow of gas may be laminar, turbulent, unsteady, unstable, fluctuating, or the flow of gas may have any other appropriate flow condition or combination of flow conditions as steady uniform flow is not required for all embodiments.

In some embodiments, it may be desirable to provide a gap between the gas flow passage and the debris shield or a portion thereof, for example to prevent damage to the optical window and/or to allow for greater manufacturing tolerances on both components. Accordingly, in some embodiments, an optics shield may be configured to position a debris shield or an optical window spaced apart from the gas flow passage by a distance D. Although a gap may be desirable in some embodiments, it should be appreciated that it may be desirable for the gap to be as small as possible, for example to reduce a volume of gas which may flow through the gap. Accordingly, in various embodiments, the distance D may be any appropriate distance. For example, the distance D may be 10 microns, 50 microns, 100 microns, 200 microns, 500 microns, 1 millimeter, or any other distance appropriate for a given application. Additionally, although a gap is depicted and described, it should further be appreciated that in some embodiments, the debris shield may be in direct contact with the gas flow passage, for example to prevent gas from flowing between the two components or to urge gas to enter the gas flow passage either exclusively or primarily through the one or more nozzles.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. An optics shield for use in an additive manufacturing system having an optics assembly configured to direct laser energy toward a build surface to fuse a portion of a precursor material on the build surface, the optics shield comprising:
a debris shield including an optical window configured to permit the laser energy to pass through the debris shield and configured to prevent fusion products released during fusion of the precursor material contacting a portion of the optics assembly, and
a gas flow passage configured for positioning between the optical window and the build surface, the gas flow passage configured to direct a flow of gas away from the optical window to resist movement of the fusion products through the gas flow passage toward the debris shield.

2. The optics shield of claim 1, wherein the optics shield further comprises a gas flow plenum coupled to an entrance of the gas flow passage.

3. The optics shield of claim 2, wherein the gas flow plenum includes a gas inlet for coupling to a gas source, the gas inlet comprising a muffler or a diffuser.

4. The optics shield of claim 2, wherein the debris shield is disposed within the gas flow plenum.

5. The optics shield of claim 1, wherein an entrance of the gas flow passage comprises a plurality of nozzles.

6. The optics shield of claim 5, wherein the plurality of nozzles forms crenellations at the entrance of the gas flow passage.

7. The optics shield of claim 5, wherein each nozzle is shaped to guide a flow of gas into the nozzle.

8. The optics shield of claim 1, wherein an entrance of the gas flow passage includes first and second groups of nozzles configured to direct gas flow toward each other.

9. The optics shield of claim 8, wherein the gas flow passage includes a tubular wall having a proximal end portion and extends away from the debris shield to a distal end portion, the proximal end portion including the first and second groups of nozzles.

10. The optics shield of claim 9, wherein the tubular wall has first and second flat wall sections that extend from the proximal end portion to the distal end portion, the proximal end portion of the first flat wall section including the first group of nozzles and the proximal end portion of the second flat wall section including the second group of nozzles.

11. The optics shield of claim 10, wherein each nozzle of the first and second groups of nozzles comprises a gap formed in the respective first or second flat wall section.

12. The optics shield of claim 10, wherein the first and second flat wall sections taper toward each other from the proximal end portion to the distal end portion.

13. The optics shield of claim 1, wherein the gas flow passage is defined by a tubular wall having a proximal end portion and extends away from the debris shield to a distal end portion, the proximal end portion including a plurality of gaps in the tubular wall forming a plurality of nozzles to direct the flow of gas into the gas flow passage.

14. The optics shield of claim 13, wherein the debris shield includes a portion positioned over the plurality of nozzles at the proximal end portion of the tubular wall.

15. The optics shield of claim 14, wherein the portion of the debris shield positioned over the plurality of nozzles is spaced apart from the tubular wall.

16. The optics shield of claim 1, wherein the debris shield further comprises a frame at least partially surrounding the optical window, the frame configured to selectively engage with a locating mechanism of the optics shield.

17. The optics shield of claim 16, wherein the frame includes a locating bore sized and shaped to selectively receive a locating pin of the locating mechanism, the locating pin configured to be selectively engaged with or disengaged from the locating bore.

18. The optics shield of claim 17, wherein the locating pin is configured to be selectively engaged with or disengaged from the locating bore by a camming arrangement comprising:
a spring in contact with the locating pin providing a biasing force to urge the locating pin in a first direction to engage the locating pin with the locating bore,
a cam follower of the locating pin biased in the first direction against a cam fixed to a camshaft,
a cam lever at an end of the camshaft configured to be turned by a user to rotate the cam to urge the locating pin in a second direction opposite the first direction to overcome the biasing force to selectively disengage the locating pin from the locating bore.

19. The optics shield of claim 1, further comprising a housing, the gas flow passage extending from or through a portion of the housing, the debris shield insertable into and removable from the housing through an opening of the housing.

20. The optics shield of claim 19, wherein the housing forms a gas flow plenum couplable between a gas source and an entrance of the gas flow passage, and wherein the debris shield is insertable into and removable from the gas flow plenum through a slot of the housing, the slot configured to form a gas-tight seal with the debris shield.

21. A method of resisting contact with a portion of an optics assembly of an additive manufacturing system by fusion products released during fusion of a precursor material on a build surface in an additive manufacturing process, the method comprising:
passing laser energy through an optical window of a debris shield disposed between a portion of the optics assembly and the build surface, and
producing a flow of gas towards the build surface through a gas flow passage disposed between the optical window and the build surface, the flow of gas resisting movement of the fusion products through the gas flow passage towards the portion of the optics assembly.

22. The method of claim 21, wherein producing the flow of gas towards the build surface through the gas flow passage comprises providing gas in a gas flow plenum and causing the gas to flow from the gas flow plenum into the gas flow passage.

23. The method of claim 22, wherein providing gas in the gas flow plenum comprises introducing the flow of gas into the gas flow plenum through a muffler or a diffuser.

24. The method of claim 22, wherein causing the gas to flow into the gas flow passage comprises causing the gas to flow around the debris shield within the gas flow plenum into the gas flow passage.

25. The method of claim 21, wherein producing the flow of gas towards the build surface through the gas flow passage comprises passing the flow of gas through a plurality of nozzles formed in an entrance of the gas flow passage.

26. The method of claim 25, wherein passing the flow of gas through the plurality of nozzles comprises passing a first portion of the flow of gas through a first group of the plurality of nozzles and passing a second portion of the flow of gas through a second group of the plurality of nozzles, the first and second portions of the flow of gas flowing toward each other.

27. The method of claim 25, wherein passing the flow of gas through the plurality of nozzles comprises passing the flow of gas through a plurality of gaps formed in the entrance of the gas flow passage.

28. The method of claim 27, wherein passing the flow of gas through the plurality of gaps comprises passing a first portion of the flow of gas through a first group of the plurality of gaps and passing a second portion of the flow of gas through a second group of the plurality of gaps, the first and second portions of the flow of gas flowing toward each other.

29. The method of claim 21, wherein the debris shield is a first debris shield, the method further comprising removing the first debris shield from an optics shield of the additive manufacturing system and installing a second debris shield in the optics shield.

30. The method of claim 29, wherein removing the first debris shield comprises disengaging a locating pin of the optics shield from a locating bore of the debris shield.

31. The method of claim 21, further comprising fusing the precursor material with the laser energy to form one or more parts on the build surface.

32. A part manufactured using the method of claim 21.
